(19) United States
(12) Patent Application Publication
(10) Pub. No.: US 2026/0202658 A1
(43) Pub. Date: Jul. 16, 2026

(54) MULTI-AXIS ARTICULATING BINOCULARS

(71) Applicants: Raymond Reed Kwong, Annapolis, MD (US); Christian Nielsen, Palm Coast, FL (US); Javier Gordillo, Pribram (CZ); Martin Polak, Drasov (CZ)

(72) Inventors: Raymond Reed Kwong, Annapolis, MD (US); Christian Nielsen, Palm Coast, FL (US); Javier Gordillo, Pribram (CZ); Martin Polak, Drasov (CZ)

(21) Appl. No.: 19/448,016

(22) Filed: Jan. 13, 2026

Related U.S. Application Data
(60) Provisional application No. 63/744,765, filed on Jan. 13, 2025.

(51) Int. Cl. G02B 23/18; G02B 7/12

(52) U.S. Cl. CPC G02B 23/18; G02B 7/12

(57) ABSTRACT

Disclosed are multi-axis articulating binoculars configured to enhance functionality, depth perception, and maneuverability in both daylight and low-light environments. The binoculars include left and right optical barrels mounted to a central body through hinges that provide articulation along multiple axes, enabling adjustment of interpupillary distance (IPD) and expansion of the effective field of view (FOV). In certain embodiments, horizontal articulation of the barrels allows outward angling to increase the combined FOV beyond conventional fixed systems, providing situational awareness comparable to quad night vision devices at reduced cost and weight. The binoculars further incorporate a dual-mode infrared (IR) illumination system with selectable wavelengths, such as 850 nm and 1064 nm, to provide adaptability across different environmental and operational conditions. Structural components may be formed from lightweight carbon fiber composites to improve handling, strength-to-weight ratio, and thermal performance, thereby enabling extended, reliable operation in demanding field applications.

### CROSS REFERENCE TO RELATED APPLICATIONS

This application claims priority from a U.S. Provisional Patent Appl. No 63/744,765, filed on 01/13/2025, which is incorporated herein by reference in its entirety.

### FIELD OF INVENTION

The present invention relates generally to optical viewing devices, and more particularly to binoculars configured with multi-axis articulation for enhanced adjustability and with multiple wavelength infrared illuminators for improved adaptability and performance in low-light or no-light conditions.

### BACKGROUND

Binoculars are essential and versatile optical instruments used across a wide range of applications. They allow users to view distant objects with magnification and stereoscopic depth perception. Common fields of use include bird watching, sightseeing, astronomy, outdoor exploration, military operations, and surveillance. A binocular generally consists of a pair of telescopes mounted on a single frame to enable simultaneous viewing with both eyes.

The performance and usability of binoculars are influenced by multiple factors, including the quality of the optical components and the configuration of the supporting frame. Considerable effort has been directed toward improving both aspects to enhance clarity, comfort, and functionality. In particular, frame design significantly affects ergonomics, handling, and maneuverability, thereby impacting overall user experience.

Night vision binoculars integrate advanced technologies to extend visibility under low-light or thermal conditions. Despite these advancements, conventional night vision binoculars still present notable drawbacks. Standard objective lens and eyepiece arrangements typically operate at approximately a 1:1 ratio and provide a field of view (FOV) of around 40 degrees. This configuration often leads to depth perception issues, manifesting as a tunnel-like viewing effect. Efforts to increase the FOV—for example, to 50 degrees while retaining the 1:1 ratio—yield only marginal improvements and do not sufficiently overcome the inherent limitations.

Accordingly, there remains a need for improved binocular designs that offer greater adaptability, enhanced depth perception, and improved maneuverability, particularly in demanding low-light and night-time operational environments.

### SUMMARY OF THE INVENTION

The following presents a simplified summary of one or more embodiments of the present invention to provide a basic understanding of such embodiments. This summary is not intended to provide an exhaustive explanation of all contemplated embodiments, nor to identify key or critical elements. Rather, it is intended to introduce certain inventive concepts in a simplified form as a prelude to the more detailed description that follows.

An object of the present invention is to provide binoculars with multi-axis articulation that improve functionality, depth perception, and maneuverability, particularly in low-light and night-time conditions.

In one aspect, the binoculars are configured to articulate along multiple axes to enable both interpupillary distance (IPD) adjustment and horizontal articulation for field of view (FOV) expansion. Unlike conventional binoculars constrained to the optical FOV of a single telescope pair, the disclosed configuration allows each optical channel to pivot outward, thereby increasing the user’s effective combined FOV. For instance, in a binocular system employing 40-degree optics, horizontal articulation can expand the combined FOV by approximately 15–20 degrees. Similarly, in systems with 50-degree optics, the effective FOV can be expanded up to approximately 85 degrees.

### BRIEF DESCRIPTION OF DRAWINGS

The accompanying drawings, which are incorporated herein and form a part of the specification, illustrate exemplary embodiments of the present invention. Together with the description, the drawings serve to explain principles of the invention and enable a person skilled in the art to make and use the invention.

FIG. 1 is a perspective view of a binocular in accordance with an exemplary embodiment of the present invention.

FIG. 2 is another perspective view of the binocular in accordance with an exemplary embodiment of the present invention.

FIG. 3 is a top view of the binocular in accordance with an exemplary embodiment of the present invention.

FIG. 4 is a bottom view of the binocular in accordance with an exemplary embodiment of the present invention.

FIG. 5 is a side view of the binocular in accordance with an exemplary embodiment of the present invention.

FIG. 6 is another side view of the binocular in accordance with an exemplary embodiment of the present invention.

FIG. 7 is a perspective view of another embodiment of the binocular in accordance with the present invention.

FIG. 8 shows another perspective view of the binocular in accordance with an exemplary embodiment of the present invention.

FIG. 9 shows another perspective view of the binocular in accordance with an exemplary embodiment of the present invention.

FIG. 10 shows a top view of the binocular in accordance with an exemplary embodiment of the present invention.

FIG. 11 shows another perspective view of the binocular in accordance with an exemplary embodiment of the present invention.

FIG. 12 shows another perspective view of the binocular in accordance with an exemplary embodiment of the present invention.

### DETAILED DESCRIPTION

Subject matter of the present invention will now be described more fully hereinafter with reference to the accompanying drawings, which form a part of this specification and illustrate specific exemplary embodiments. It should be understood, however, that the invention may be embodied in many different forms and should not be construed as limited to the embodiments set forth herein. Rather, the embodiments are provided so that this disclosure will satisfy applicable legal requirements and convey the scope of the inventive concepts to those skilled in the art. The disclosed subject matter may take the form of methods, devices, components, systems, or any combination thereof.

The term “exemplary” as used herein is intended to mean “serving as an example, instance, or illustration,” and is not intended to suggest that a described embodiment is preferred or superior to other embodiments. Similarly, references to “embodiments of the present invention” do not require that all embodiments include the particular features, advantages, or modes of operation described.

The terminology used herein is for descriptive purposes only and is not intended to be limiting. As used herein, the singular forms “a,” “an,” and “the” include the plural forms unless the context clearly dictates otherwise. The terms “comprises,” “comprising,” “includes,” and “including” specify the presence of stated features, elements, or components but do not preclude the presence or addition of other features, elements, or components.

The following detailed description sets forth the best currently contemplated mode or modes for carrying out exemplary embodiments of the invention. The description is presented for purposes of illustration and explanation and is not to be interpreted as limiting the scope of the invention, which is defined solely by the claims of any issued patent.

### Reference Numerals:

100 Binocular

105 Left barrel

110 Right barrel

115 Central body

120 Objective lens

125 Ocular lens

130 IR tube

135 FOV adjuster

140 IPD adjuster

145 Power button

148 Dial for the adjustable gain for the image intensifier tube

150 Dual IR illuminator switch

155 IR lights

200 Binocular

205 Left barrel

210 Right barrel

215 Central body

220 Objective lens

225 Ocular lens

230 Power button

235 IR lights

240 Interchangeable helmet (gear) attachment

245 1^{st} axis of rotation of joint

250 2^{nd} axis of rotation of the joint;

255 Axial locks

260 Gain control

265 Pivot joint

270 Electronics and battery compartment

275 Battery lock

280 connector for external battery

285 LED illumination

The present invention relates to binoculars with enhanced functionality and maneuverability. Disclosed embodiments provide multi-axis articulating binoculars that integrate multiple discrete and highly accurate wavelength emitters in the infrared spectrum. The binoculars are configured for operation in dark or low-light conditions to deliver improved image quality and extended detection range. In certain embodiments, the binoculars incorporate a dual-mode illuminator selectable across multiple wavelengths, enabling both airborne crews and ground operators to maintain visibility in extremely low-light environments. Under daylight or illuminated conditions, the illuminator is operable to emit visible light perceivable by the naked eye. When used in conjunction with night vision systems, the illuminator floods a target area with infrared (IR) light, thereby enabling effective viewing in near-total darkness. In one embodiment, the IR illumination operates at approximately 850 nm, corresponding to a peak IR wavelength commonly supported by night vision devices. In further embodiments, the binoculars may include IR emitters operable at approximately 850 nm and 1065 nm, thereby covering a broader spectrum and enhancing visibility across a wider range of dark operating conditions.

The disclosed binoculars are configured to articulate along multiple axes, enabling adjustment of both interpupillary distance (IPD) and effective field of view (FOV). In certain embodiments, a horizontal articulation mechanism permits outward angling of the optical barrels to expand the combined FOV perceived by the user. When used in conjunction with improved optical elements, this articulation may provide an effective FOV of up to approximately 80 degrees, thereby enhancing depth perception and situational awareness beyond that of conventional binocular systems.

Conventional binoculars allow adjustment of the IPD to match the spacing between a user’s eyes, typically using a friction-based mechanism that maintains its setting until disturbed by external force. In contrast, the disclosed binoculars may employ a locking mechanism, such as a screw or clamp, to secure the IPD in place. Once locked, the user may then adjust the FOV independently to optimize lateral coverage. As a result, the disclosed system provides an image similar to quad night-vision systems used in military operations, presenting a central circular image with peripheral extensions to the right and left, thereby expanding the perceived viewing envelope.

Unlike quad systems, which provide a fixed FOV, the disclosed binoculars allow user-adjustable FOV expansion through the same locking mechanism that secures the IPD. For example, a binocular system employing 50-degree optics may be articulated outward to expand the combined FOV up to approximately 85 degrees. While such expansion may introduce minor distortion at the periphery, the significant increase in situational awareness can be lifesaving in night vision operations and outweighs any reduction in image resolution. In addition, the disclosed design provides these advantages at a significantly lower cost compared to conventional quad systems.

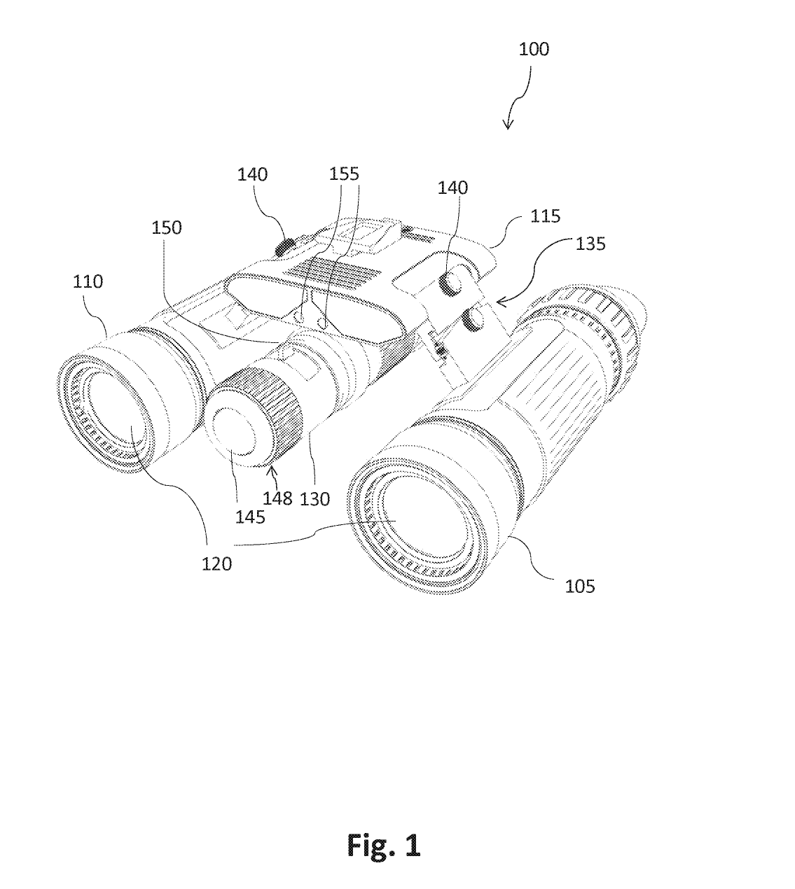

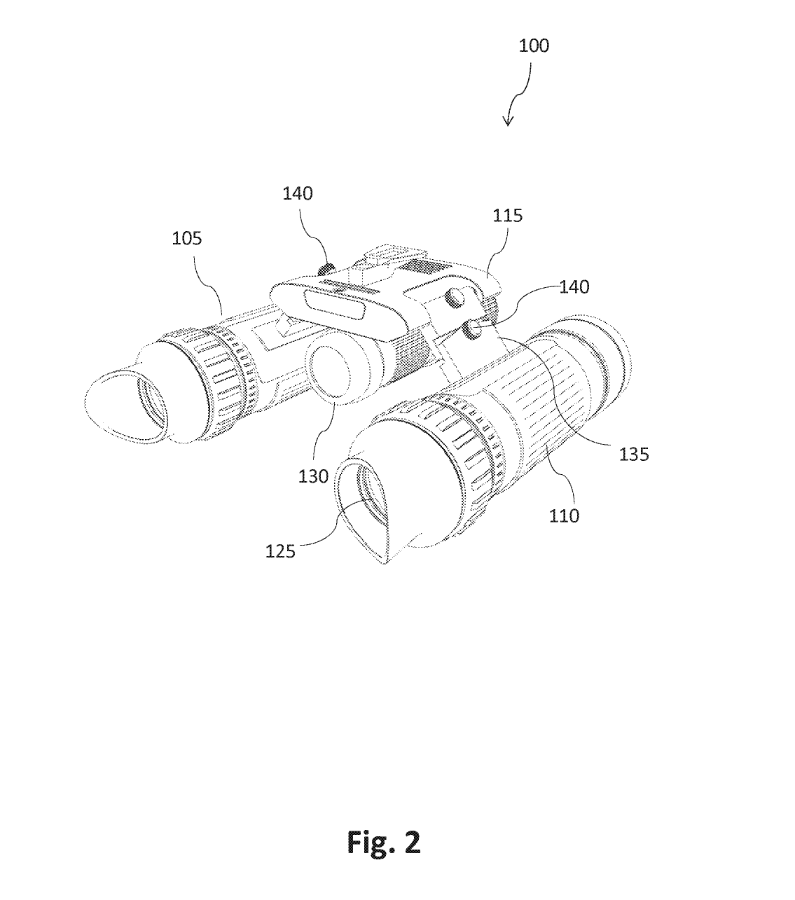

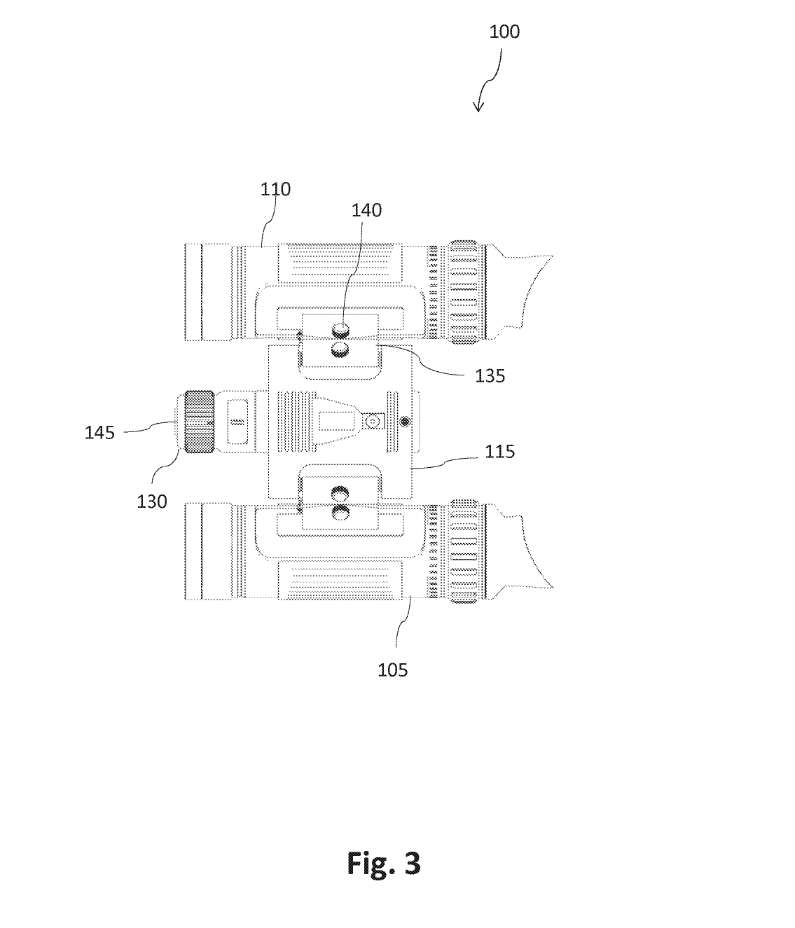

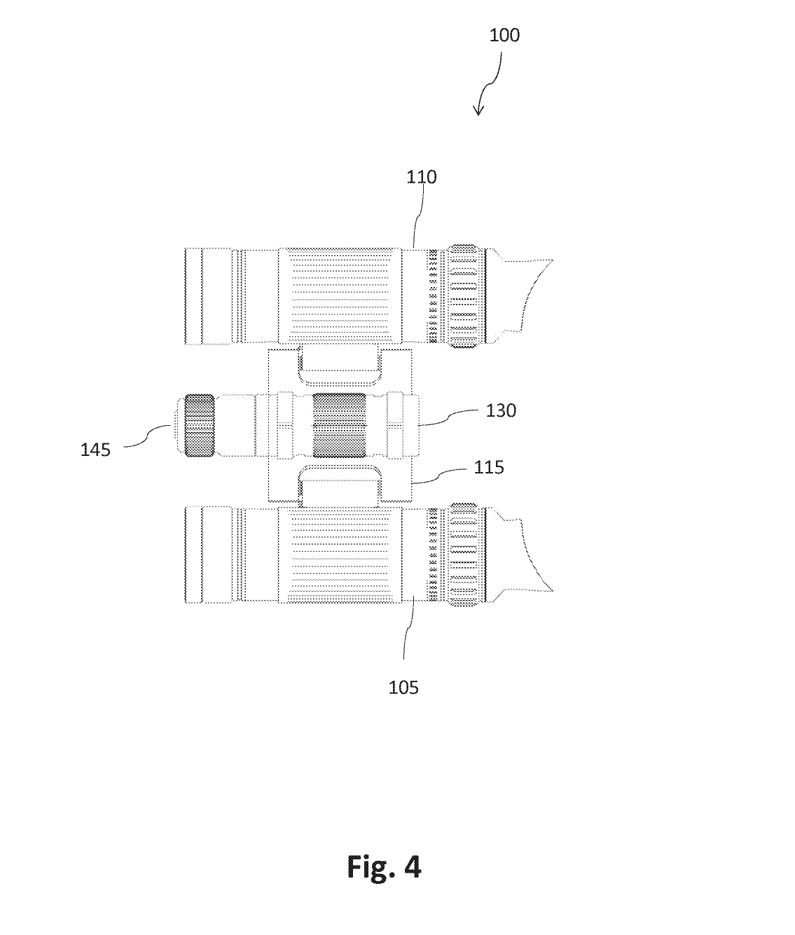

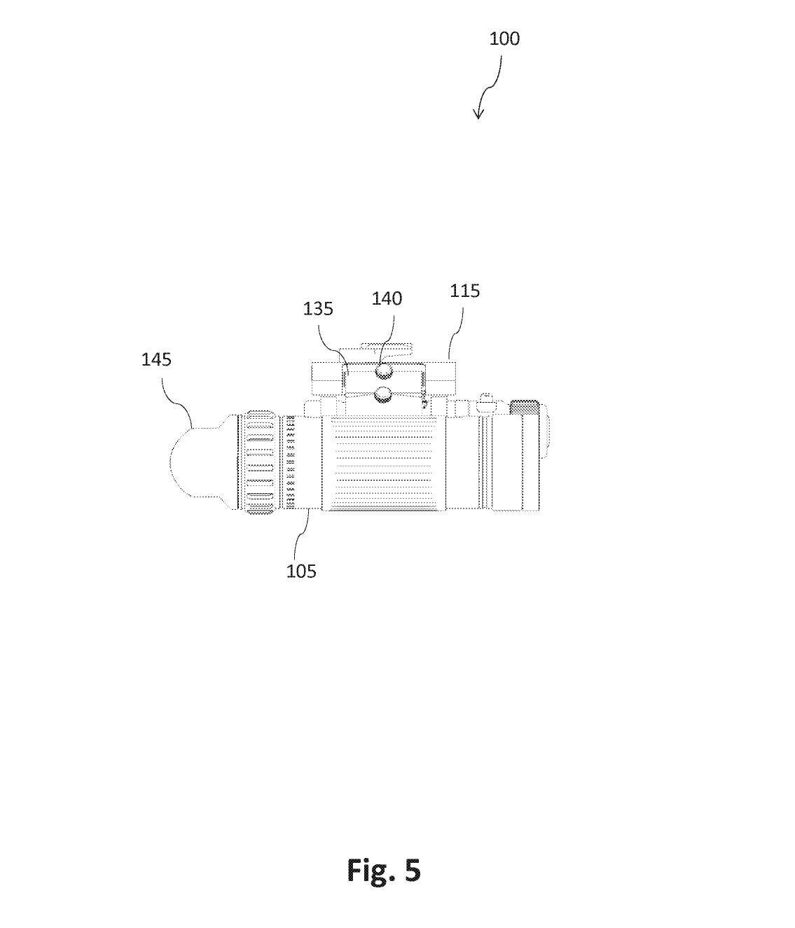

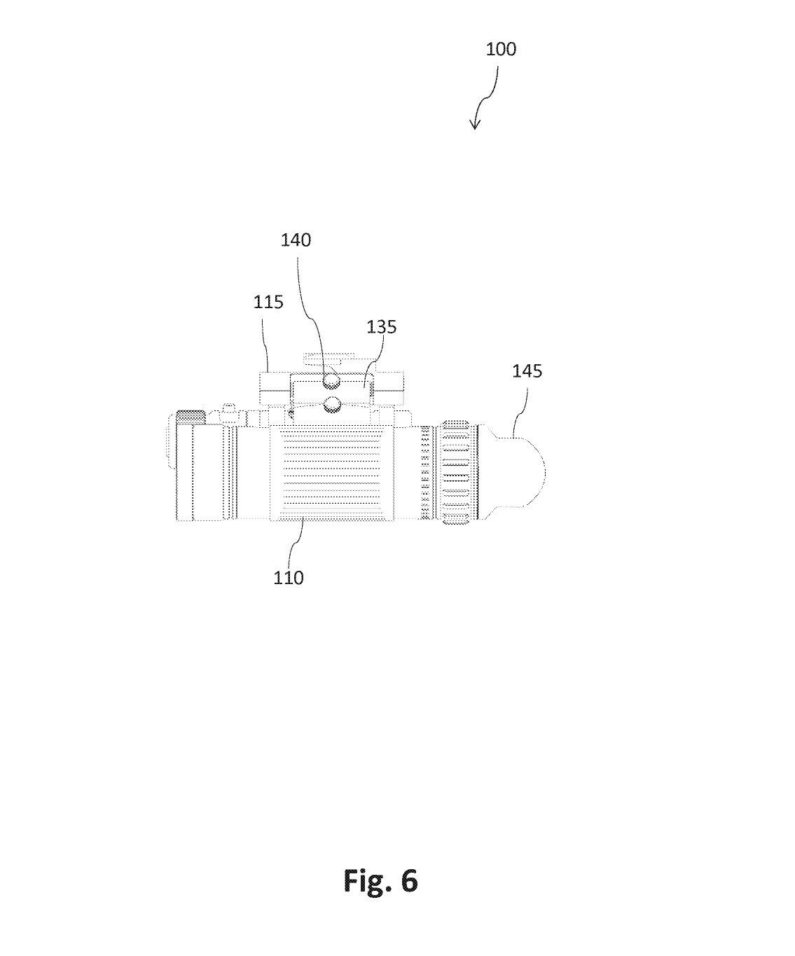

Referring now to FIG. 1–6, various views of a binocular 100 are shown. The binocular 100 includes a left barrel 105 and a right barrel 110. In one embodiment, the barrels are formed from an injection-molded hybrid short-stick carbon fiber composite, although other suitable materials may be used. This composite provides a high strength-to-weight ratio, reduced overall weight, and favorable thermal conductivity. These properties improve handling and maneuverability while also assisting in dissipating heat generated by internal electronics, maintaining a stable operating temperature during extended use. Each barrel further includes an objective lens 120 and an ocular lens 125.

The left barrel 105 and the right barrel 110 are mounted to a central body 115 by respective left and right binocular hinges. Each hinge may include a field-of-view (FOV) adjuster 135 and an interpupillary distance (IPD) adjuster 140. The adjusters enable articulation along multiple axes, allowing the binoculars to be customized both for IPD spacing and for outward angling of the barrels to expand the effective FOV. The IPD adjustment and FOV articulation operate in coordination, permitting seamless adjustment between eye spacing and lateral viewing expansion.

In one embodiment, the FOV adjuster 135 provides a range of expansion depending on the underlying optical configuration. For example, in a binocular system employing 40-degree optics, horizontal articulation may increase the effective FOV by approximately 15–20 degrees. In a system employing 50-degree optics, the effective FOV may be expanded up to approximately 85 degrees. These values are exemplary only, and other degrees of expansion fall within the scope of the present invention.

An infrared (IR) tube 130 may be mounted to a bottom portion of the central body 115 between the left barrel 105 and the right barrel 110. In certain embodiments, two IR lights 155 are mounted to a front side of the central body 115. The IR illumination system may be selectively activated or deactivated by a power button 145 and controlled through an illuminator control switch 150. In one embodiment, the power button 145 is a push-type switch that toggles the IR system between on and off states, while the illuminator control switch 150 enables mode selection between different IR wavelengths. A dial 148 may also be positioned on the IR tube 130 to adjust the gain of an image intensifier tube. Other button styles, switch types, or control arrangements may be employed without departing from the scope of the present invention.

In operation, actuating the power button 145 energizes the IR illumination system. The FOV and IPD of the binoculars may be independently adjusted using the FOV adjuster 135 and IPD adjuster 140. The illuminator control switch 150 is operable to select the desired wavelength mode. In one embodiment, sliding the switch 150 in a first direction activates an 850 nm illumination mode, while sliding in the opposite direction activates a 1064 nm mode. In another embodiment, a third stop position activates both modes simultaneously. Other wavelength configurations, switch mechanisms, and control schemes are contemplated.

The IPD adjuster 140 may include a rotatable knob or equivalent mechanism that, when loosened, permits adjustment of the interpupillary distance. Once the desired spacing is set, the knob is tightened to lock the adjustment. Similarly, the FOV adjuster 135 may be loosened to permit outward articulation of the barrels and tightened to secure the expanded FOV. This arrangement enables the user to optimize the binocular configuration to individual preference while maintaining stability during operation.

The disclosed binoculars illumination systems. In night vision applications, the dual-mode illuminator floods an area with IR light, ensuring visibility under extremely dark conditions. In one embodiment, the IR illumination operates at approximately 850 nm, a wavelength commonly compatible with standard night vision systems. In further embodiments, the IR system may provide additional wavelengths, including but not limited to approximately 1064 nm, variable ranges from about 850 nm to 1100 nm, 1550 nm, 1750 nm, 2050 nm, or combinations thereof. Such configurations provide broad spectral coverage and enhanced adaptability under diverse operating environments.

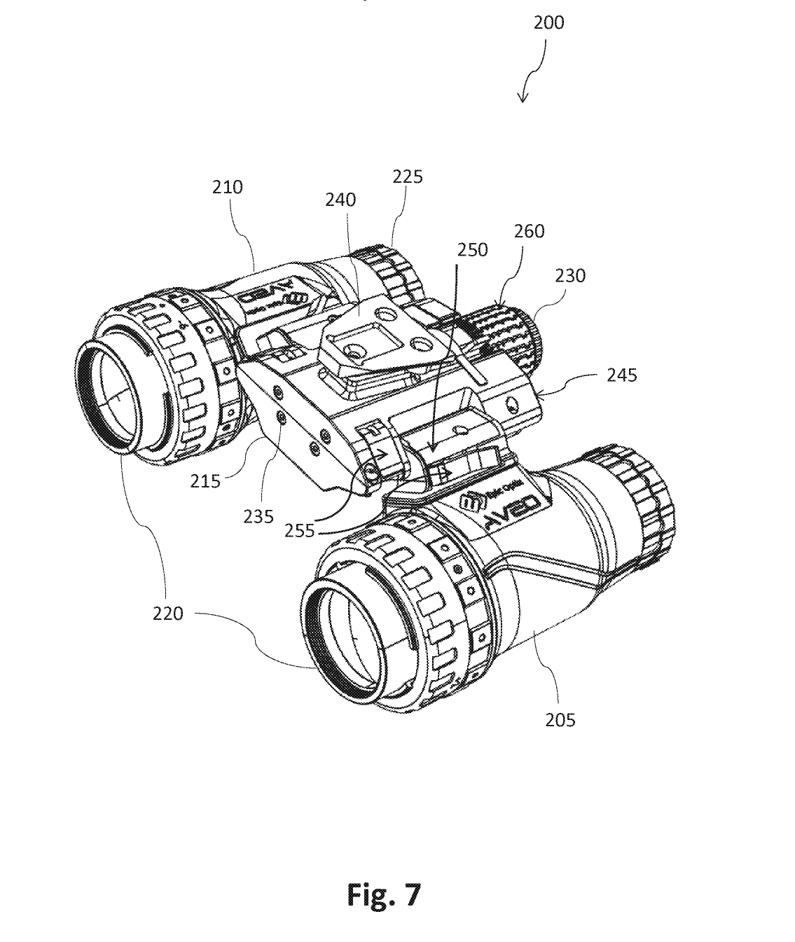

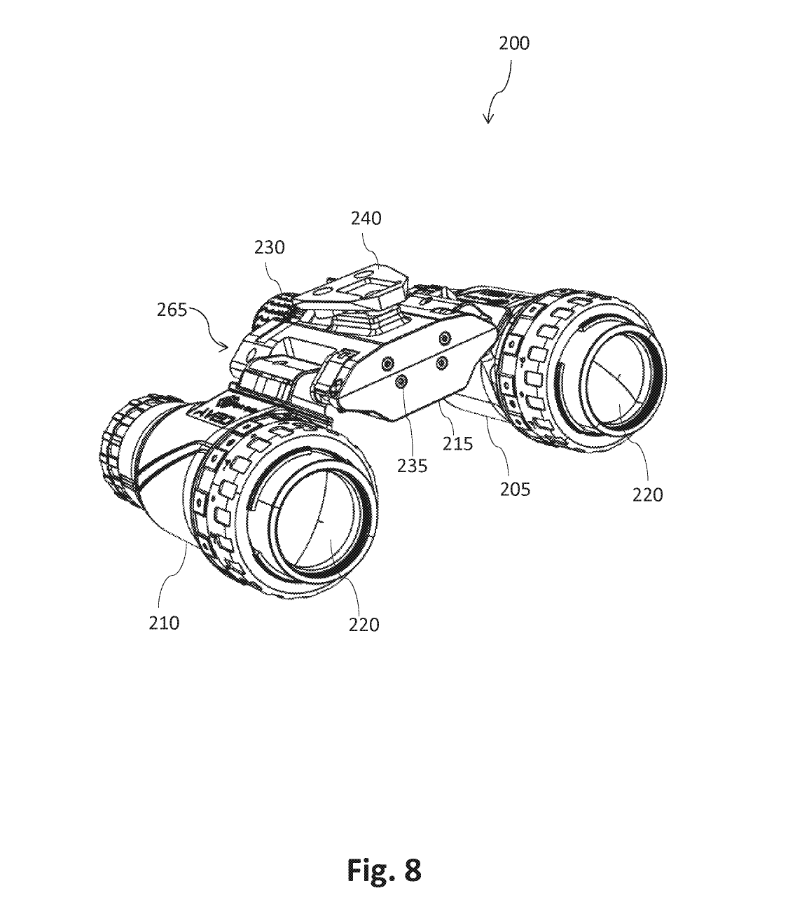

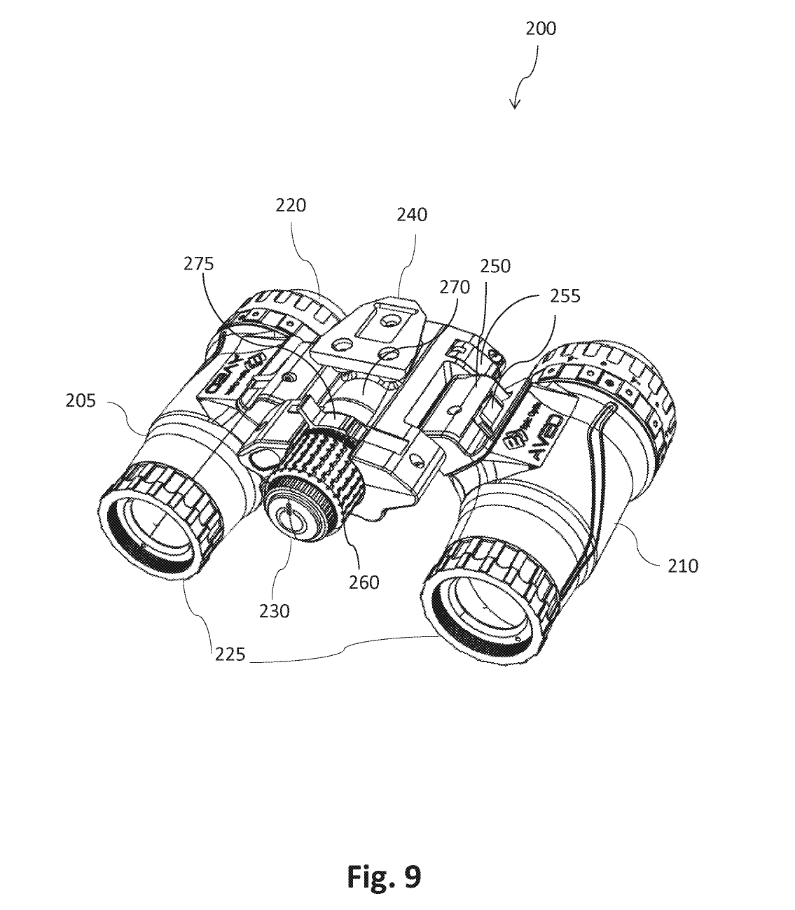

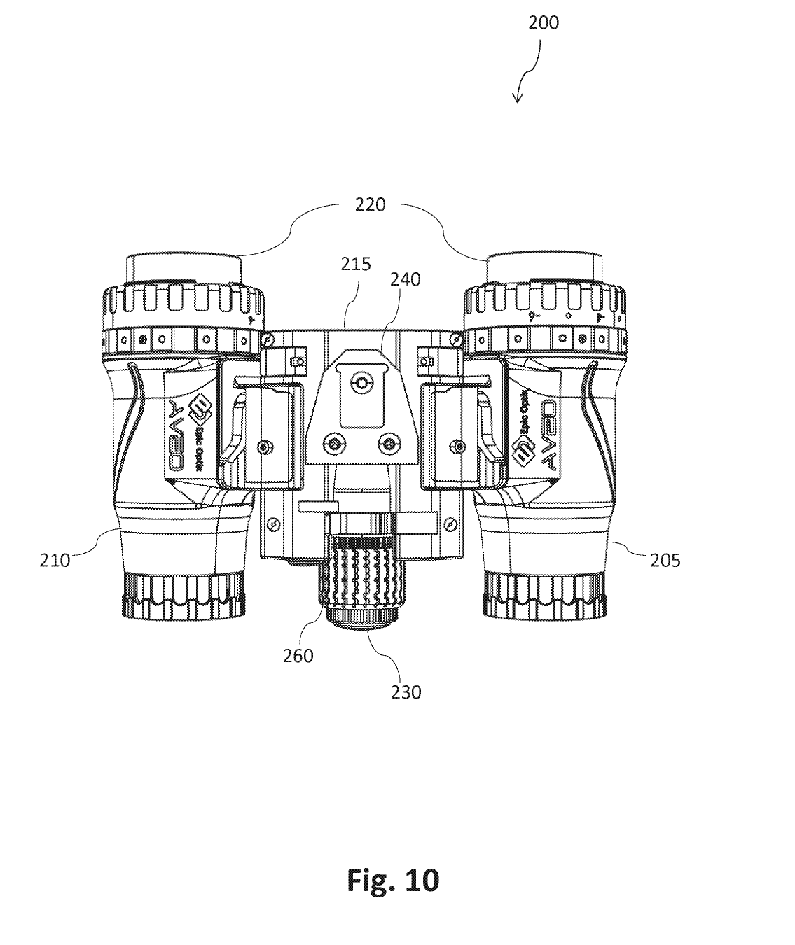

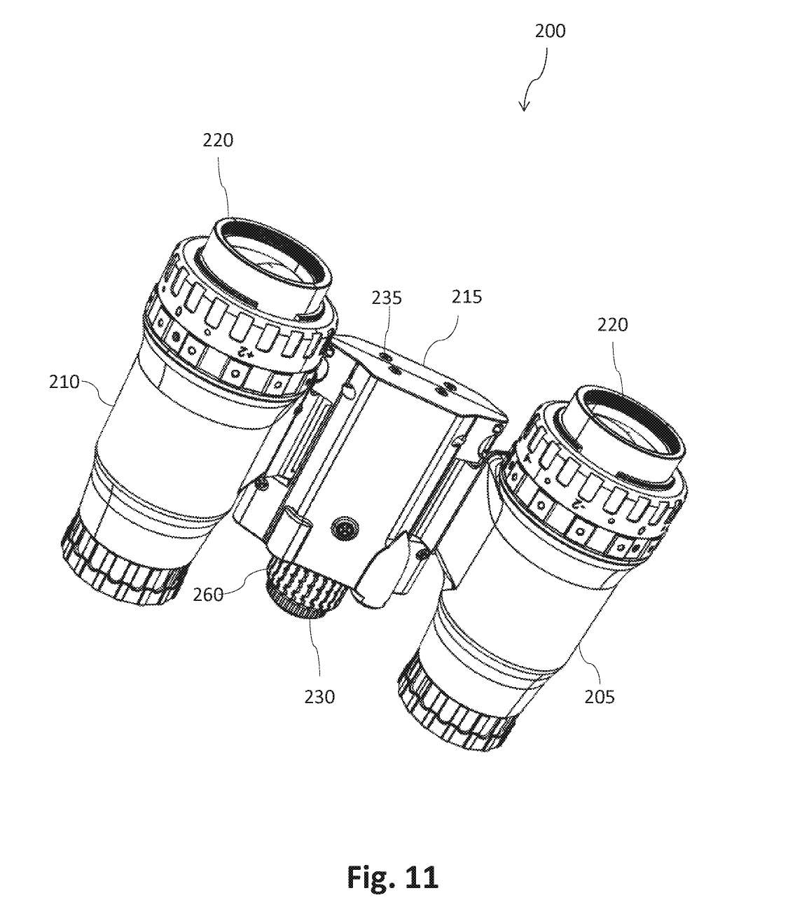

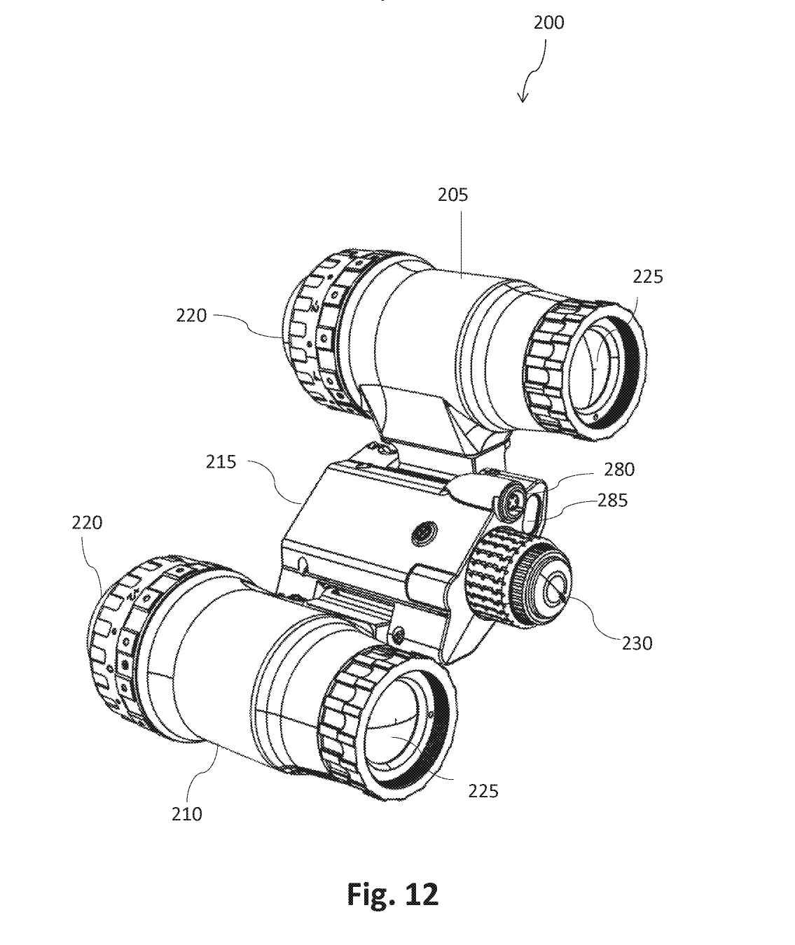

Referring to FIG. 7–12, another embodiment of the binoculars 200 is illustrated. The binoculars 200 are generally similar to the binoculars 100 described above, except for certain structural and functional differences described herein. For brevity, not all features common to both embodiments are repeated. The binoculars 200 include a left barrel 205 and a right barrel 210. A central body 215 extends between and interconnects the left barrel 205 and the right barrel 210, and further houses electronic components of the binoculars 200. Each of the left barrel 205 and the right barrel 210 includes an objective lens 220 and an ocular lens 225.

A tubular shaft protrudes rearwardly from the central body 215. A dial 260 is mounted on the tubular shaft and is configured for gain control. Adjacent the dial 260, a power button 230 is provided and is operable to selectively activate or deactivate the IR illumination system. One or more IR light sources 235 protrude from a front side of the central body 215. The IR light sources may include one or more LEDs or other emitters selected to operate across a wide range of spectral wavelengths. Mounted on an upper portion of the central body 215 is an interchangeable helmet or gear attachment 240.

The left barrel 205 and the right barrel 210 are mounted to the central body 215 via respective left and right binocular hinges 265. Each hinge includes a first axis of rotation 245 and a second axis of rotation 250, thereby permitting multi-axis adjustment of the barrels relative to the central body. The hinges further include axis locks 255 configured to selectively secure the barrels in a desired angular position. The central body 215 further defines an electronics and battery compartment 270 and includes a battery lock 275 for retaining a power source therein.

The disclosed binoculars 100 further include a connector 280 configured to receive an external battery, thereby enabling connection to a portable or remote power source. Additionally, an LED illumination source 285 is provided within the central body and may be configured to provide auxiliary visible-light illumination or system status indication.

In certain implementations, the disclosed hinge of the binocular allows articulation in two dimensions i.e., IPD and FOV, allowing up to 85 degrees FOV.

In certain implementations, the disclosed binocular includes two IR Illuminators- 850 nm and 1064 nm that allow the maximum spectral range.

While the foregoing detailed description sets forth embodiments presently contemplated as best modes, those skilled in the art will recognize that variations, modifications, combinations, and equivalents are possible without departing from the scope and spirit of the invention. Accordingly, the invention should not be limited to the embodiments described herein, but rather defined by the claims of any patent issuing from this disclosure.

What is claimed is:

1. A binocular system comprising:
a left barrel and a right barrel, each including an optical lens and an ocular lens; and
a central body, wherein the left barrel and the right barrel are mounted to the central body through left and right binocular hinges, wherein each of the left and right binocular hinges comprises:
a field of view (FOV) adjuster configured for adjusting FOV; and
an interpupillary distance (IPD) adjuster configured for adjusting IPD.

2. The binocular system of claim 1, further comprises:
an infrared unit mounted to a front side of the central body and comprising infrared emitters operable at different wavelengths.

3. The binocular system of claim 2, wherein the infrared emitters are operable at approximately 850 nm and approximately 1064 nm.

4. The binocular system of claim 1, wherein the IPD adjuster comprises a locking mechanism configured to secure the interpupillary distance during operation.

5. The binocular system of claim 4, wherein the FOV adjuster is operable to expand the effective field of view up to approximately 80–85 degrees.

6. The binocular system of claim 5, wherein the FOV adjuster is configured to provide optimization and maximization of the field of view by expanding the objective lenses from parallel to a wider angle.

7. The binocular system of claim 1, wherein at least the left barrel and the right barrel are made using injection molding from thermally responsive Short Stick Carbon Fiber composite.

8. The binocular system of claim 1, further comprising a gain adjustment dial operatively coupled to an image intensifier tube.

9. A method of operating a binocular system, the method comprising:
providing a binocular system comprising:
a left barrel and a right barrel, each including an optical lens and an ocular lens, and
a central body, wherein the left barrel and the right barrel are mounted to the central body through left and right binocular hinges, wherein each of the left and right binocular hinges comprises:
a field of view (FOV) adjuster configured for adjusting FOV, and
an interpupillary distance (IPD) adjuster configured for adjusting IPD;
adjusting an interpupillary distance (IPD) between a left optical barrel and a right optical barrel using the interpupillary distance (IPD) adjuster;
locking the IPD at a selected distance; and
articulating the left and right optical barrels outward relative to the central body using a field-of-view (FOV) adjuster to expand an effective field of view beyond an optical field of view of the barrels.

10. The method of claim 9, wherein the binocular system further comprises:
an infrared unit mounted to a front side of the central body and comprising infrared emitters operable at different wavelengths.

11. The method of claim 9, wherein articulating the left and right optical barrels expands the effective field of view from approximately 50 degrees to approximately 85 degrees.

12. The method of claim 10, wherein the infrared emitters are operable at approximately 850 nm and approximately 1064 nm.

13. The method of claim 9, wherein the IPD adjuster comprises a locking mechanism configured to secure the interpupillary distance during operation.

14. The method system of claim 11, wherein the FOV adjuster is configured to provide optimization and maximization of the field of view by expanding the objective lenses from parallel to a wider angle.
